(19) United States
(12) Patent Application Publication
(10) Pub. No.: US 2022/0072672 A1
(43) Pub. Date: Mar. 10, 2022

(54) APPARATUS FOR CUTTING, GRINDING, AND POLISHING WORK PIECES AT MULTIPLE AXES

(71) Applicant: SERGEY NIKOLENKO, DENVER, CO (US)

(72) Inventor: SERGEY NIKOLENKO, DENVER, CO (US)

(21) Appl. No.: 17/467,249

(22) Filed: Sep. 5, 2021

Related U.S. Application Data
(60) Provisional application No. 63/074,484, filed on Sep. 4, 2020.

(51) Int. Cl. B23Q 11/10; B23Q 1/03

(52) U.S. Cl. CPC B23Q 11/1076; B23Q 1/032

(57) ABSTRACT

An apparatus and related assembly that may be used for cutting, grinding, and polishing surfaces is disclosed. The apparatus may comprise an extended rail, a saddle, movably mounted on top of the extended rail, a side block connected to the lateral side of the saddle and one or more clamps that may securely fasten a machining surface to the extended rail. The apparatus may further comprise a coolant pipe for ejecting coolant onto the machining surface, an index plate attached to the side block onto which a power tool may be mounted using an angled connector that allows the power tool to be fixed onto the index plate at a plurality of angles. Herein, the power tool may comprise of a motor and a set of replaceable blades rotatably connected to the motor for performing operations including cutting, grinding, or polishing of the machining surface.

### TECHNICAL FIELD

The present disclosure is generally related to power driven tools. More particularly, the present disclosure is related to an apparatus and related assembly for processing edges and surfaces of various work pieces.

### BACKGROUND

Power driven tools are used to perform a variety of operations including cutting, sanding, polishing, stripping, and the like. Such tools typically include a plurality of components including motors, drive assemblies, different types of connectors, and other related components typically found in grinders, polishers, cutters, and related mounting assemblies. Although these devices have proven useful for polishing or abrading relatively flat surfaces, they are not effective and are difficult to use on contoured surfaces. Polishing, or levigation, is the mechanical finishing process for materials adapted to eliminate, or at least reduce, the surface roughness by means of abrasives of various nature in accordance with the material to be polished or process used. Furthermore, precisely cutting/polishing/dressing the surfaces and edges of hard materials such as stones, concrete, and the like may require precision mounting apparatuses as well. These precision mounting apparatuses are either in one way very expensive or their form factor cause constraints like space limitations, limitations with respect to the surface which can be machined, and so on.

Angle grinders offer a fast and effective way to cut and grind a variety of surfaces and materials. But they can also be dangerous. As a result, highly skilled technicians are required to use them safely and effectively. The angle grinder needs a precise adjustment to grind or cut the surface according to the required angle. Since the operator is always in contact with the machine to ensure precise control and operation, the chances of injury to the operator increase substantially. Instances of such operational dangers can be decreased to an extent by using efficient mounting assemblies which focus on safety without compromising operational flexibility.

The present problem faced by the industry is the lack of a suitable mount to fix the grinding machine and set a particular angle to work on large surfaces such as iron sheets, marbles, and so on. Even though there are various technologies where an existing portable grinding machine can be mounted and can be operated at a particular angle, the area of operation of these technologies are very limited. They can only be used in a particular size of material, or else the material to be machined should be carried to the apparatus, which requires substantial manpower in the case of large and heavy materials. In addition, a perfect way to use the coolant while doing machining operations is also lacking in the present arts. An efficient cooling mechanism can considerably increase the quality of machining as it decreases the heat produced.

In general, the edges and sides of granite and other stones are polished using portable disc grinders or polishers. In order to do a good job with such devices, a great deal of time and experience is required. Another problem with portable devices is that the power cord is usually located on the floor behind the operator where cooling water accumulates, increasing the likelihood of electrical shock and the possibility of tripping on the cord. In the hands of an inexperienced or unskilled operator, the use of such devices often results in uneven beveled edges. Even with an experienced operator, holding the grinder or polisher at a certain angle for a lengthy period can result in muscle strain. In any event, the task of beveling edges evenly is difficult.

Although there are large column moving surface grinding machines widely used in industrial applications that are sophisticated technology-wise, they cannot be used in some surfaces which are irregular, having a taper, or else can't be adjusted to a particular angle to cut a portion at the required angle. In addition, they are of the kind where we need to bring the material to be processed into the machine since the weight of the machines are more and they are not portable. This is not practically possible in every case due to some space limitations or because of the heaviness of specimens to be machined. Moreover, the costs related to these technologies are very huge, which a small-scale industry cannot afford, and these machines are not portable and consume heavy power for their working. In addition, the required space for a dedicated large surface grinding machine is very large. These constraints point out the need for new mechanisms where multiple operations can be done economically without compromising safety.

U.S. Pat. No. 8,162,726B1 discloses an edge dressing grinder tool used for making a continuous straight, vertical edge on a concrete, natural stone or artificial stone slab used for a countertop or table. The tool includes a manually operated hand grinder with a perpendicularly aligned grinding disc or pad mounted on a drive shaft. Attached to the head of the grinder is a forward extending, longitudinally aligned bracket. Extending laterally from the bracket are two slide arms and an adjustment rod. Mounted on the distal ends of the slide arms is a guide plate with a low friction, sliding plate. Mounted along the rear edge of the guide plate are two, transversely aligned wheels that press against a raised edge formed on a rigid fence that is fixed in position on the top surface of the work piece and parallel to the edge. The end of the adjacent rod engages a nut assembly mounted on the slide plate that allows the distance between the grinder's head and the guide plate to be selectively adjusted.

U.S. Pat. No. 9,694,464B2 discloses an apparatus for polishing the edges and sides of granite and other stones includes a hollow rectangular base for sliding along a stone surface, a yoke mounted on the base, a disc polisher pivotally mounted in the yoke for rotation around a horizontal axis between a variety of polishing orientations, and an indexing mechanism for releasably locking the polisher in such orientations.

U.S. Pat. No. 9,895,790B2 discloses a multi-abrasive tool constituted by a support on which abrasive elements are present. The abrasive elements are arranged in a manner so as to form one or more paths along which the successive abrasive elements have grain size sequentially increasing or decreasing by an arbitrary quantity when passing from on element to the next. This principle gives rise to abrasive tools with different conformation both for polishing machines and for grindstones. For roto-orbital and planetary polishing machines, and optionally orbital, such support is circular, and the grain sequence is circumferential, or radial, or in both directions. A first tool is constituted by contiguous (or non-contiguous) circular rings, that are differently abrasive. A second tool comprises differently abrasive elements arranged along the circular peripheral edge. A third tool comprises differently abrasive elements arranged along a spiral path of 360° starting from the edge. A fourth tool comprises two 180° spiral paths with reversed roughness sequences. A fourth tool comprises pairs of differently abrasive small cylinders fixed to a plate on concentric circumferences. A fifth tool is obtained directly on the plate of the polishing machine by means of reliefs and spacers for fixing differently abrasive sectors. For linear polishing machines, the abrasive support is a belt along which differently abrasive rectangular or oblique zones follow each other. For alternative polishing machines, the abrasive support is a plate shaped like the aforesaid belt. For tools to use with grindstones, the multi-abrasive element has a cylindrical rotation symmetry, or conical with rounded tip, or spherical symmetry.

U.S. Pat. No. 7,134,949B2 discloses a constant angular grinding tool comprising: a profile wheel whose grinding face is fixed at an inclination angle with respect to the axis of a spindle of a rotary electric tool; a first guide plate which is a disc member attached rotatably to a spindle between the profile wheel and the rotary electric tool so as to guide for a grinding direction by bringing the edge of the disc member into a contact with the reference level of a material; and a second guide plate which is a disc member attached rotatably to a spindle between the profile wheel and the first guide plate and whose outer peripheral end face makes contact with the edge of the material to control a grinding distance from the edge.

While the prior arts mentioned herein solved the technical problems of at least one of grinding, polishing, or cutting different surfaces, they lack in providing a modern solution that provides precision dressing capabilities that enables the apparatus to be glided across multiple axes to enable precise and continuous dressing of surfaces/edges of different work pieces.

The industry needs a simple mechanism where existing machines can be mounted on to something that can solve all or some of the above-mentioned problems while performing operations such as angle grinding or cutting, polishing, surface grinding of large surfaces etc. Apparatuses that are currently used in performing the abovementioned functions fail to provide a modern solution for precision dressing capabilities which enable the apparatus to be glided across multiple axes to enable precise and continuous dressing of surfaces/edges of different materials and cutting of large surfaces at a particular angle. Therefore, a need exists for a solution to attach the existing portable grinding machines with apparatuses that are flexible and easy to operate where the angle of operation can be adjusted laterally and longitudinally while performing operations such as grinding, cutting, polishing, and the like. Moreover, it should also address the technical problem of efficiently providing coolants to the machining surface.

### BRIEF DESCRIPTION OF THE DRAWINGS

FIG. 1 is an exemplary first perspective side view 100 of an apparatus for processing various machining surfaces according to the embodiments of the present disclosure.

FIG. 2 is an exemplary second perspective side view 200 of the apparatus with a grinding machine mounted on it according to the embodiments of the present disclosure.

FIG. 3 is an exemplary top perspective view 300 of the apparatus showing the supporting rods that connects a saddle to a side block according to the embodiments of the present disclosure.

FIG. 4 is an exemplary bottom perspective view 400 of the apparatus showing an extended rail and a clamp that tightens a machining surface to the extended rail according to the embodiments of the present disclosure.

FIG. 5 is an exemplary third perspective side view 500 of the apparatus showing an angled connector and a coolant pipe according to the embodiments of the present disclosure.

FIG. 6 is a fourth perspective side view 600 of the apparatus according to the embodiments of the present disclosure.

FIG. 7 is a first side view 700 of the apparatus according to the embodiments of the present disclosure.

FIG. 8 is a second side view 800 of the apparatus according to the embodiments of the present disclosure.

FIG. 9 is an exemplary illustration 900 of the extended rail on which the saddle glides over to perform machining operations according to the embodiments of the present disclosure.

FIG. 10 is an exemplary diagram 1000 of the saddle that moves over the extended rail according to the embodiments of the present disclosure.

FIG. 11 is an exemplary illustration 1100 of the side block saddle according to the embodiments of the present disclosure.

FIG. 12 an exemplary illustration 1200 of the clamp that may be used to fix the machining surface to the apparatus according to the embodiments of the present disclosure.

FIG. 13 is an exemplary illustration 1300 of an angle power tool used to perform various machining operations with the apparatus according to the embodiments of the present disclosure.

FIG. 14 is an exemplary illustration 1400 of the apparatus with a machining surface clamped on it showing a rod that strengthens the extended aluminum rail according to the embodiments of the present disclosure.

The drawings described herein are for illustration purposes only and are not intended to limit the scope of the present subject matter in any way.

### DETAILED DESCRIPTION

The embodiments described herein disclose an apparatus for mounting power tools such as grinding machines, cutting machines, or polishing machines safely and conveniently for performing machining operations like grinding, polishing, or cutting surfaces of various machining surfaces at different angles. The apparatus comprises of a related mounting assemblies and tools that allow the apparatus to be translated across 4 different axes to provide for comprehensive high precision operability. The apparatus allows an angle power tool to be docked onto it at multiple angles and further allows the movement of the power tool across multiple axes. Herein, the power tool may further be installed with a variety of bits/blades to perform different functions such as cutting, grinding, polishing, milling, and the like, depending upon the type and property of material that is to be processed. The apparatus allows precise continuous lateral and linear movement of the attachment (in one example, the power tool configured to work as an angle grinder) for the purpose of processing different surfaces.

The apparatus may allow larger linear cutting, grinding and profiling to be performed in perfect linear order at one or more angles depending upon the requirement of the operator. The apparatus may allow superior finishing of surfaces that may be used as countertops, surface coverings, etc. Surfaces and even the edges of different materials may be carved and polished accurately to provide better finishing using the instant apparatus. The surface upon which the apparatus performs the above-mentioned functions maybe referred to as a “work piece” throughout this document.

The apparatus may be used to process a wide range of machining surfaces including stones such as marble, granite, and the like, glass of various types, different types of sheets, panels, concrete, slabs, etc. The whole configuration is lightweight and may be easily carried around since it can be dismantled into different parts.

The specification may refer to “an”, “one” or “some” embodiment(s) in several locations. This does not necessarily imply that each such reference is to the same embodiment(s), or that the feature only applies to a single embodiment. Single feature of different embodiments may also be combined to provide other embodiments. As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

It may be noted that the terms “cutting”, “polishing”, “dressing”, “processing”, “grinding”, and “milling” may be used interchangeably according to the context of the sentence. The terms “processing” and “machining” may be used interchangeably. The terms “machining area”, “material to be machined”, “machining surface” and “work piece” may be used interchangeably throughout this document. The terms “arrangement”, “apparatus”, “assembly” and “configuration” may be used interchangeably throughout this document. The terms used herein do not restrict the scope of the present disclosure.

Before moving to the succeeding section of this disclosure that describes the working of the apparatus in detail, it is pertinent to refer to the various reference numerals provided in the drawings. In this example, the whole configuration may be divided into three sections. The primary components including the saddle, sidle block, index plate, extended rail, and connecting rods. The secondary components may include the coolant pipe, power tool, angle connector, and fasteners such as clamps. Furthermore, the tertiary components of the apparatus may include the work piece, wires, power source, blades/bits used in the power tool, and the like.

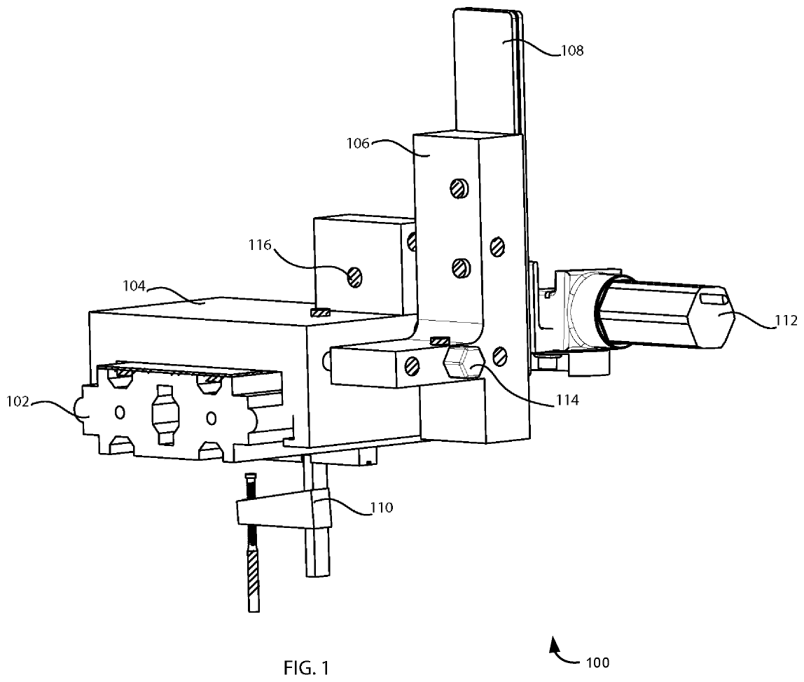

Referring to the drawings, FIG. 1 is an exemplary first perspective side view 100 of an apparatus for processing various machining surfaces. Herein a saddle 104 moves along the extended rail 102 to perform various machining operations. A side block 106 may be connected to the saddle 104 using length adjustable connecting rods. Further, the saddle 104 is connected with an index plate 108 onto which power tools may be mounted. The index plate 108 may be adjusted to modify the height of machining operations. A work piece may be mounted to the apparatus using a clamp 110 that securely fastens the apparatus to the work piece. One or more clamps may be used to securely fasten the work piece to the apparatus. Further a coolant pipe inlet 116 may be provided on the saddle for connecting the coolant pipe to the apparatus to control the heat generated during machining operations. A threaded knob 114 may be provided to adjust the distance between the saddle 104 and side block 106 using length adjustable connecting rods.

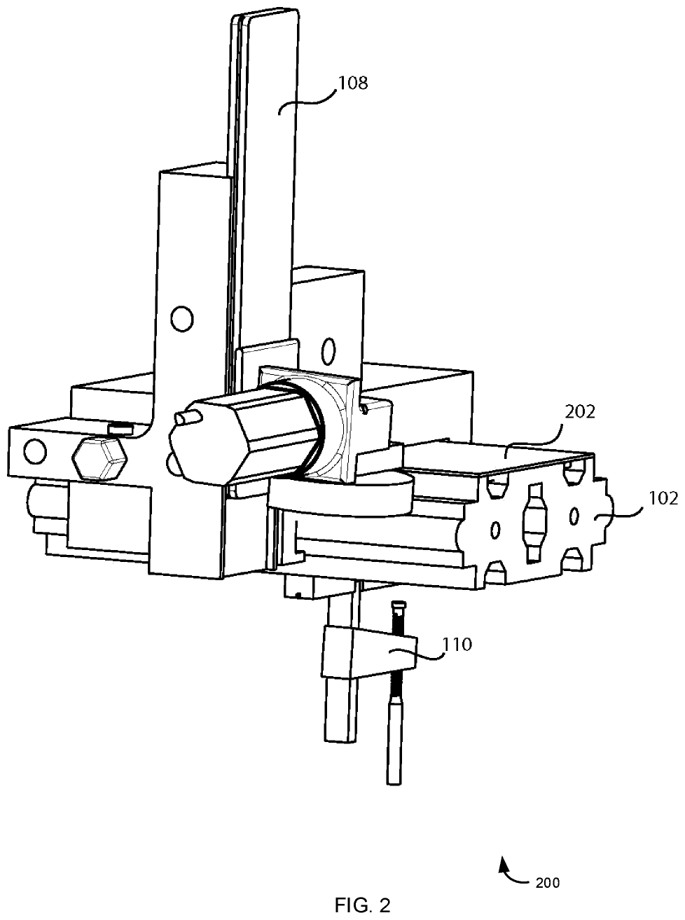

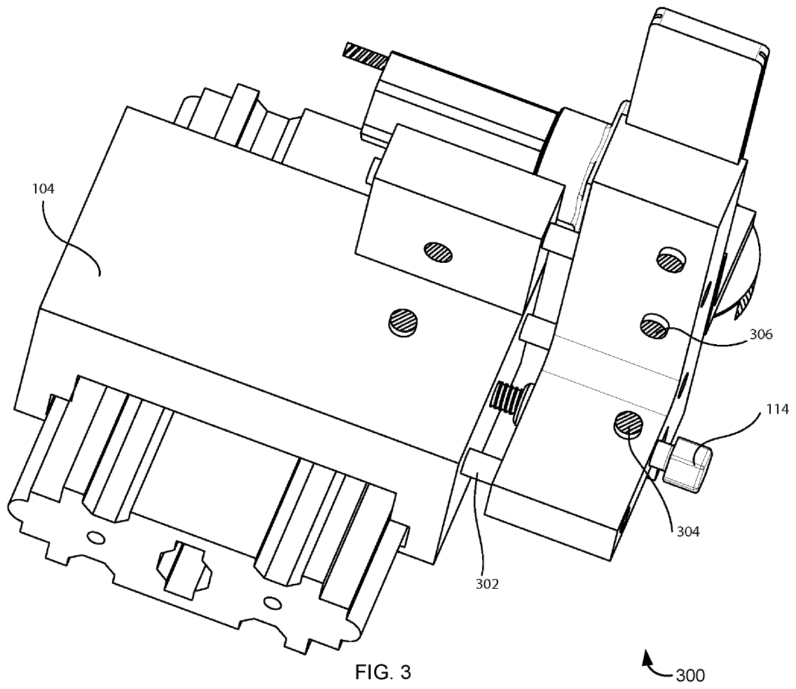

FIG. 2 is exemplary second perspective side view 200 of the apparatus with a power tool mounted on it. As illustrated in the figure, a flat thin metallic plate 202 may be placed over the extended rail 102 to ensure smooth movement of the saddle 104 over the extended rail 102. FIG. 3 is the top perspective view 300 of the apparatus showing the connecting rods 302 that connects the saddle 104 to the side block 106. The length of the connecting rod 302 may be increased or decreased to change the distance between the saddle 104 and the side block 106 using the threaded knob 114. One or more such connecting rods may be used to ensure safe mounting of the side block 106 to the saddle 104. Locking mechanisms 304 and 306 may be used to prevent the movement of the side block 106 and the power tool during machining operations.

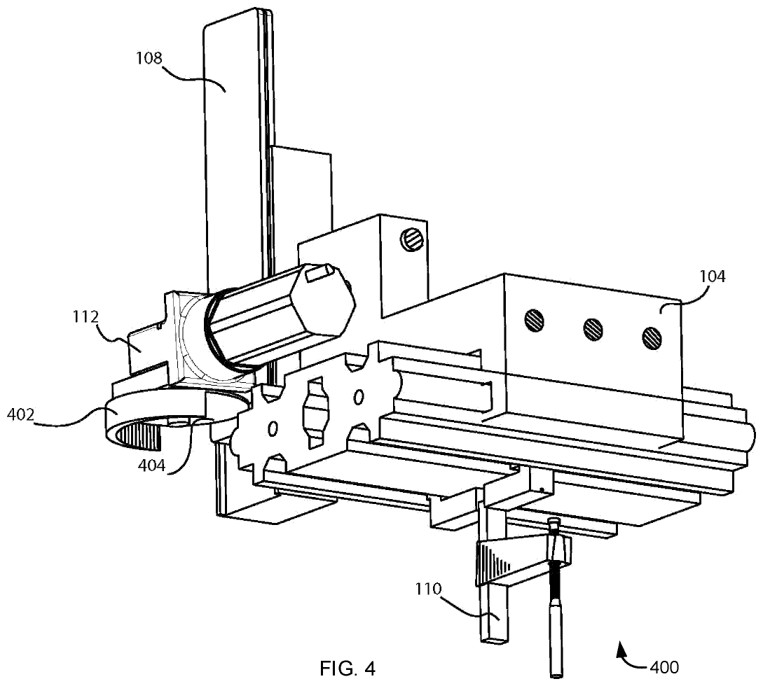

FIG. 4 is the bottom perspective view 400 of the entire configuration. 402 is the protective shield that minimizes the risk to the operator while performing machining operations and 404 is the bit/blade used in the power tool. The blade may be replaced to variety of types (for example: grinding wheel, cutting wheel, polishing wheel and so on) depending upon the type and property of work piece that is to be processed.

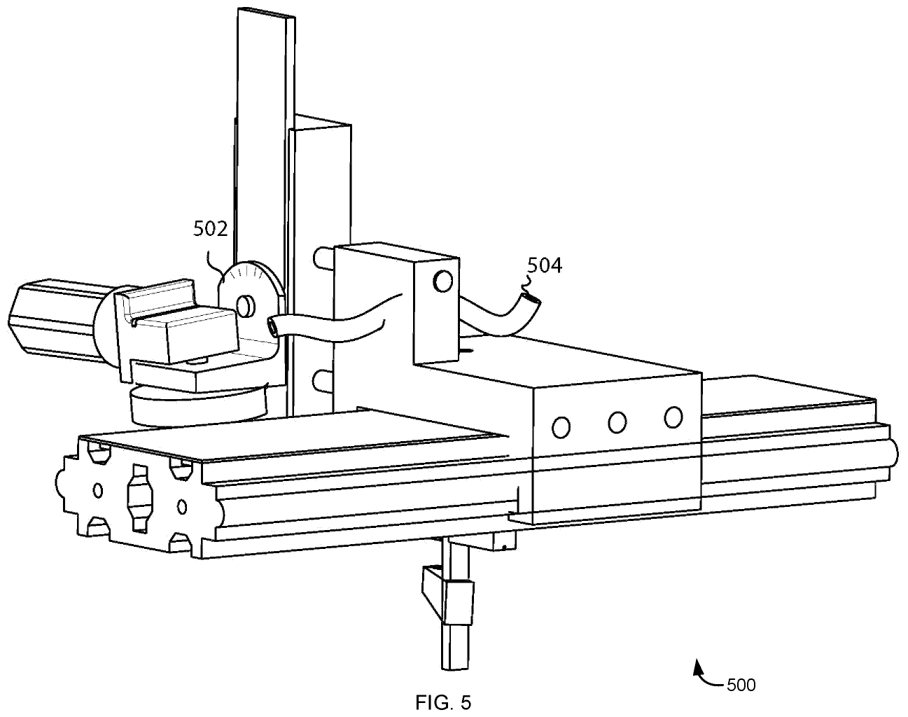

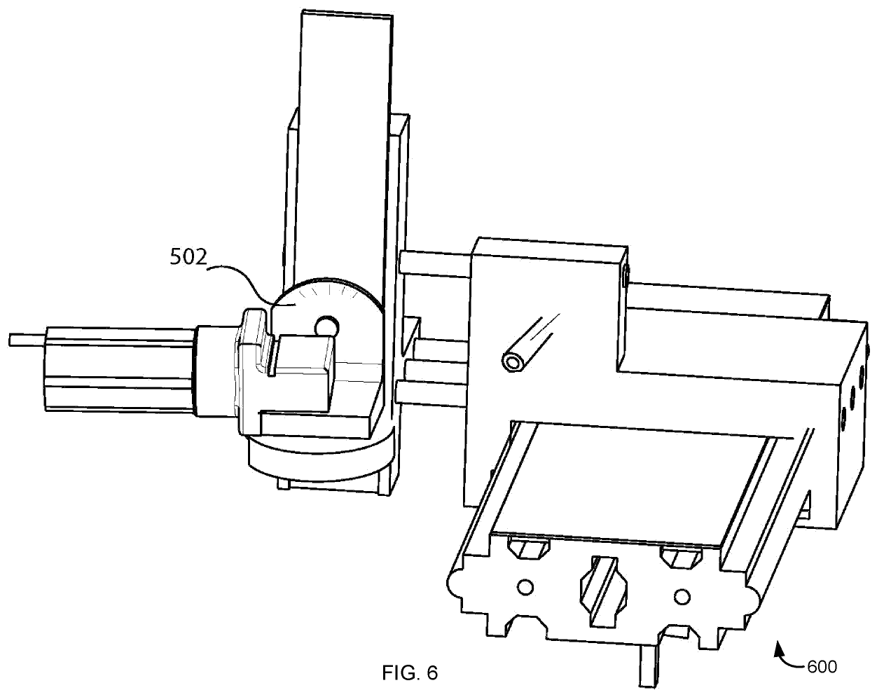

FIG. 5 is an exemplary third perspective side view 500 of the apparatus showing an angled connector 502 and a coolant pipe 504 provided on the apparatus. The angled connector 502 allows accessories such as angle grinders to be connected to the apparatus at various angles for performing multiple machining operations. Precise angles may be pre-set using the angled connector 502 before performing an operation. A coolant may be provided from an inlet via the coolant pipe 504. The coolant may allow the machining surface to cool down immediately during the machining process. The configuration of the coolant pipe 504 is provided in such a way that it does not affect the operations of the apparatus. At the same time, continuous availability of the coolant prevents the apparatus from overheating. The coolant pipe 504 may be flexible in nature so that it may be extended and pointed towards the machining area during operation. FIG. 6 is a fourth perspective side view 600 of the apparatus according to the embodiments of the present disclosure. The power tool 112 may be connected to the index plate 108 on the side block 106 using the angular connector 502 which may be rotated to any required angle by means of countersunk bolts for machining purposes.

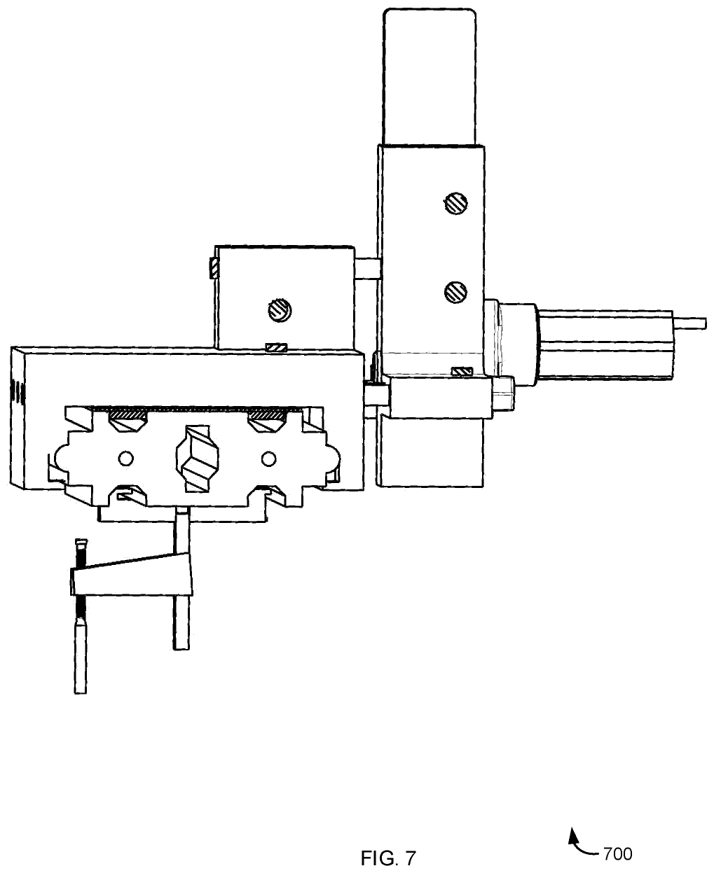

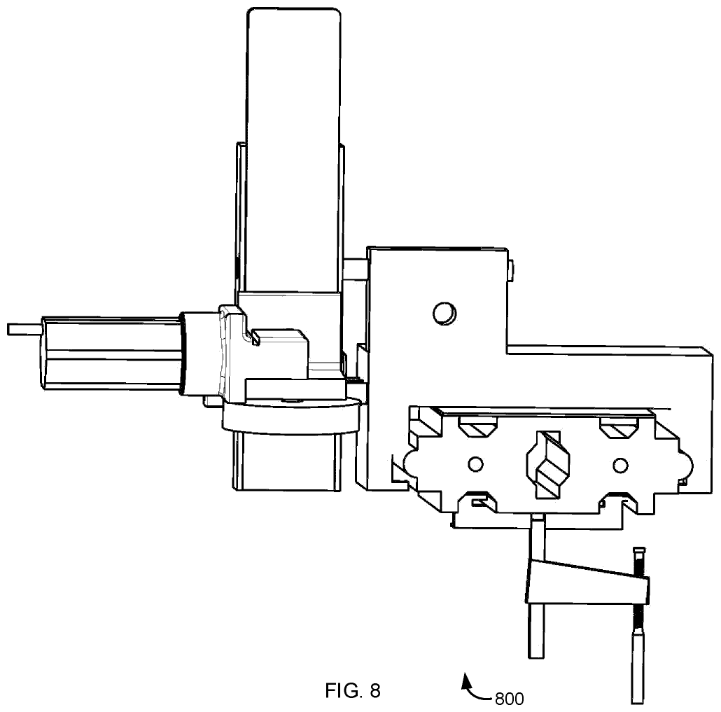

FIGS. 7 and 8 are side views 700 and 800 of the apparatus as proposed by the present disclosure. The components of the apparatus and related assemblies may be dismantled and reassembled with minimum time and manpower.

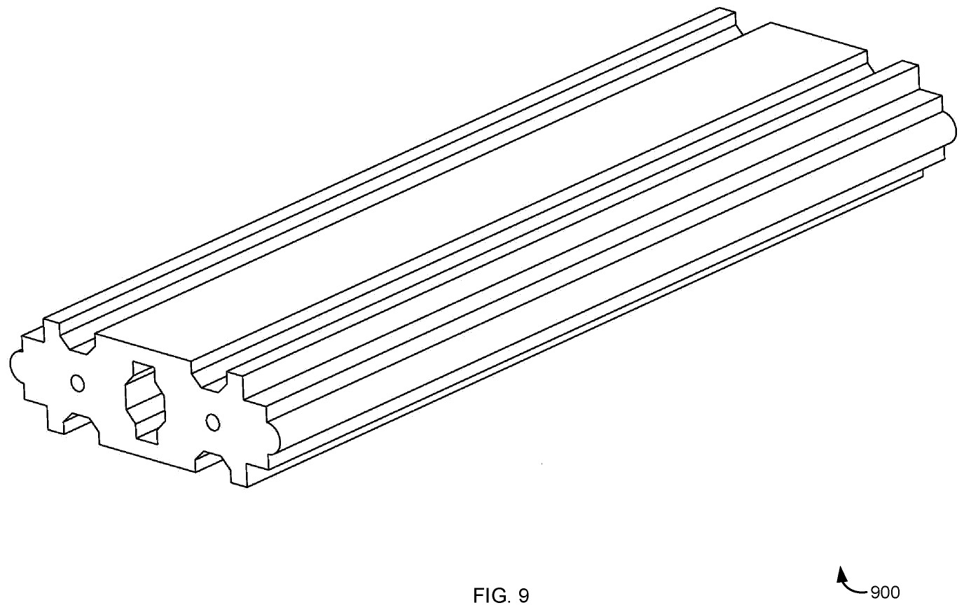

FIG. 9 is an exemplary illustration of 900 of the extended rail through which the saddle moves along to access the machining area. It is the longest element in the entire arrangement. The extended rail and the saddle may have complementing designs with components that lock onto each other flawlessly for allowing the saddle to easily move back and forth. FIG. 9 is an exemplary diagram 900 of the saddle, the part which glides across the rail. The interior side portions of the saddle locks onto the extended side portions of complementing shape of the extended rail. The saddle may move back and forth in a stable and smooth manner during the operation of the apparatus. The side block may be mounted onto the saddle using connecting rods. The connecting mechanism of the saddle and the extended rail allows fluent movement of the saddle along the extended rail. The coolant pipe may also be connected to the saddle.

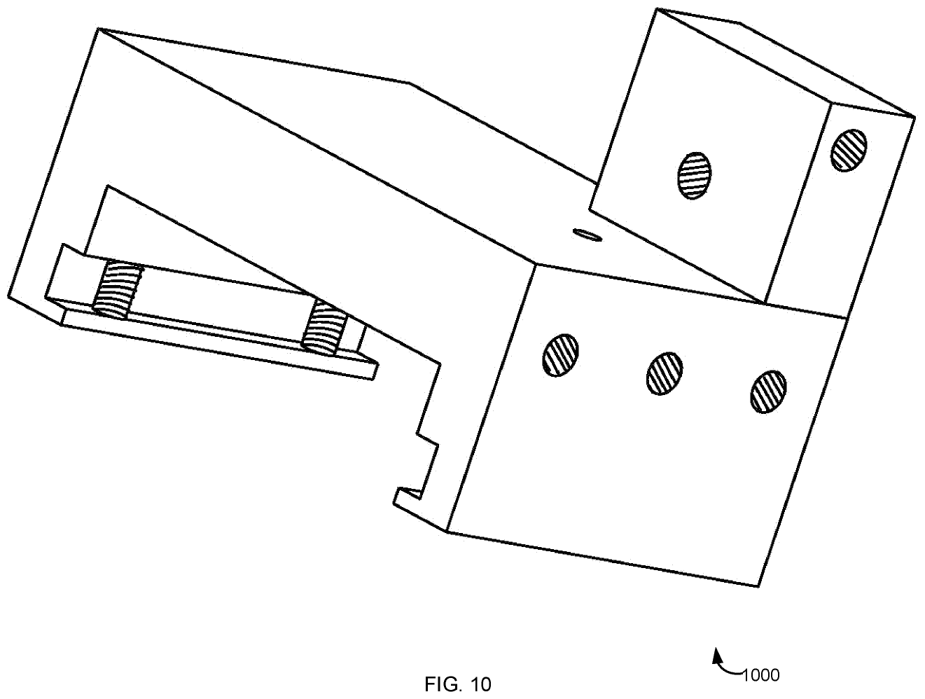

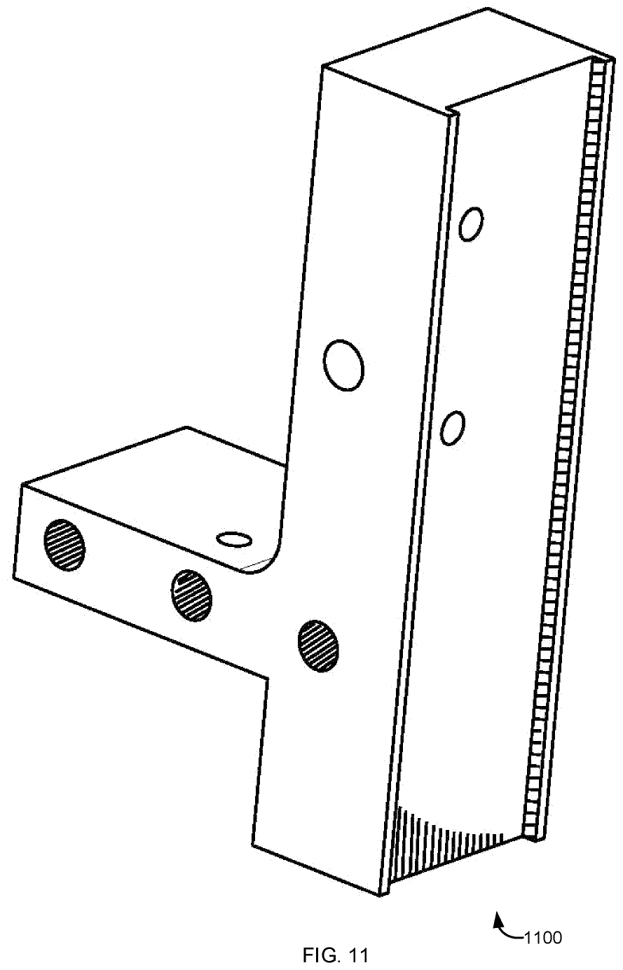

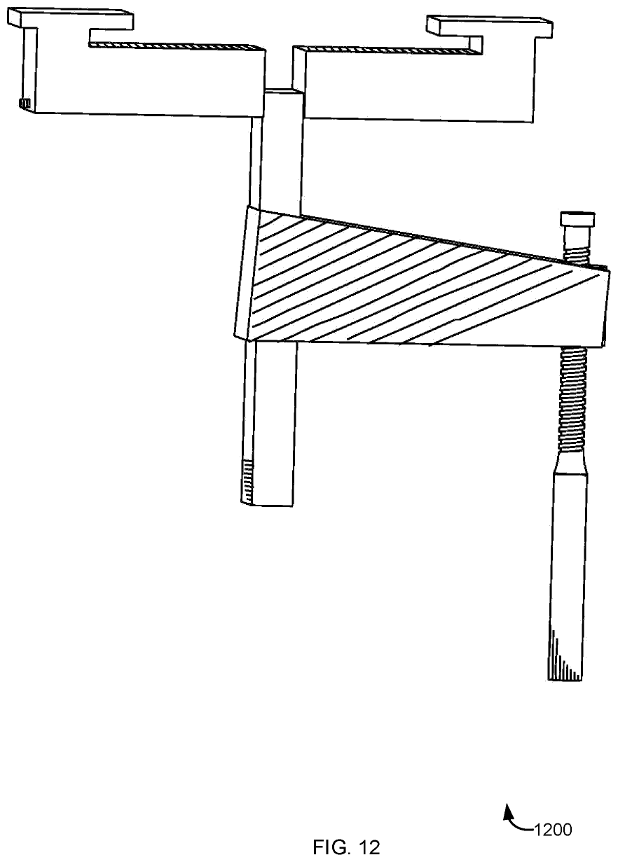

FIG. 10 is the perspective side view 1000, named as side block which supports the power tool used in this configuration. Also, the power tool can be moved upwards and downwards along the side block using the index plate connected to side block to access machining areas on work piece. FIGS. 11 and 12 are exemplary illustrations 1100 and 1200 of the clamp and power tool used in the whole configuration respectively. The clamp may securely tighten the workpiece onto the apparatus during operation. The workpiece may be clamped below the extended rail for processing it. The clamp securely grips the workpiece to the apparatus. A working table (supporting structure) may also be used wherein the clamp tightens the workpiece and the apparatus to the supporting structure.

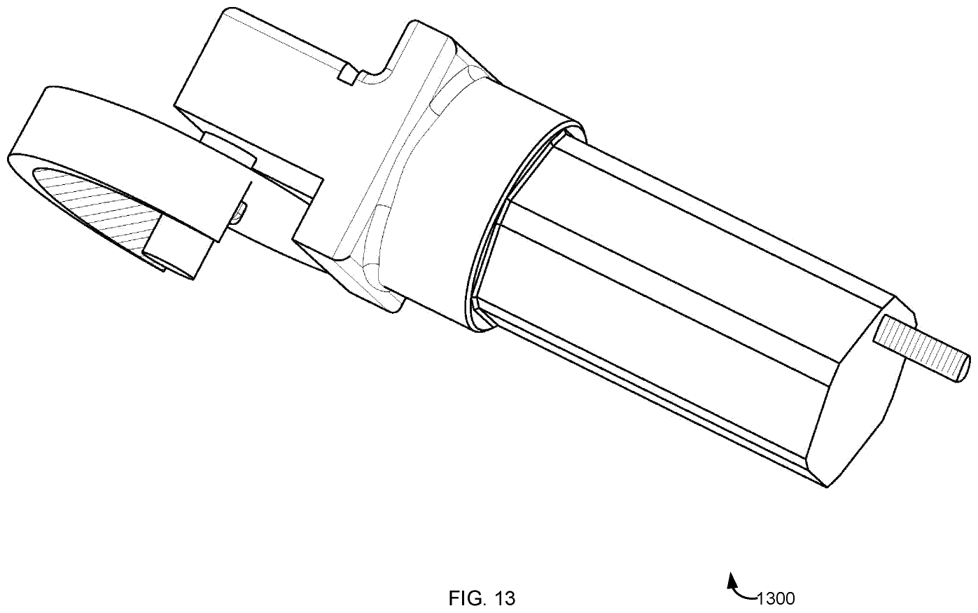

FIG. 13 is the perspective view 1300 of the angular connector used to connect the power tool to the apparatus. It may be rotated to any angle to perform machining operations. In this example, angles are marked on the angular connector with an exemplary interval of 22.5°. Although the entire apparatus is made of metal, it may be carried with minimum effort, since it is very easy to dismantle and assemble. When the existing grinding machines are used, it may be a very time-consuming process to machine tapered sides and to perform machining operations at a particular angle even for a skilled operator. The apparatus disclosed herein may overcome this disadvantage and may provide an accurate as well as safe working condition by simply attaching the existing grinding machines with a new configuration.

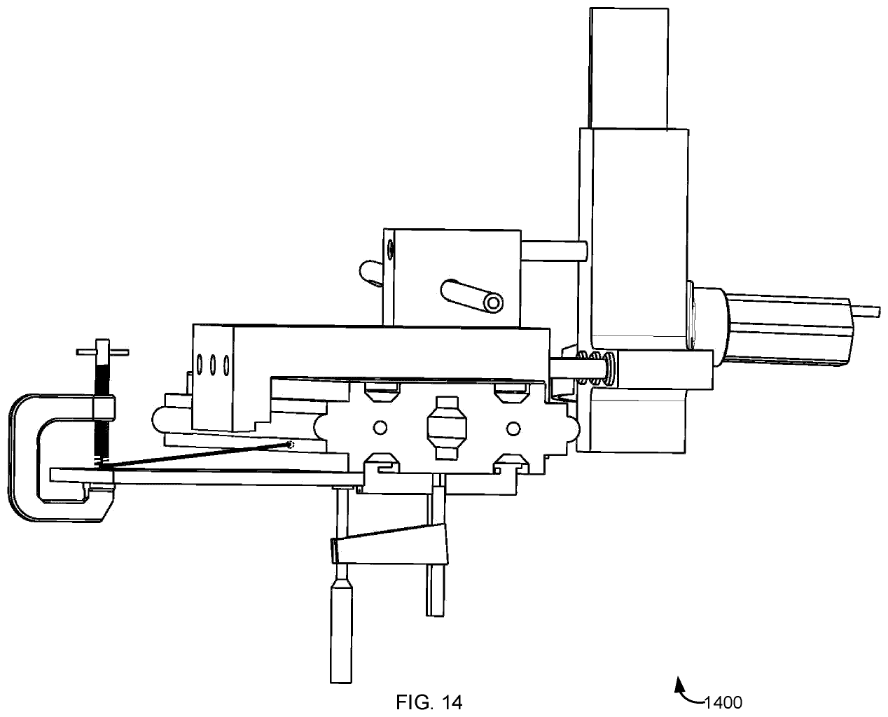

FIG. 14 is an exemplary illustration 1400 of the apparatus with a machining surface clamped on it showing a rod that strengthens the extended aluminum rail according to the embodiments of the present disclosure. Herein, an additional clamp and a rod to strengthen the extended rail may be provided as described in the figure. This configuration increases the stability and strength of the rail during operation.

The apparatus disclosed herein may be used along with a wide range of power tools. In one example, the power tool may be an angle grinder with replaceable blades. Apart from grinding, processes such as cutting, and polishing may also be performed. Power tools that perform such operations may easily be mounted to the apparatus. The entire assembly has a rigid and strong body. A part of the entire assembly is connected to the extended rail, which is long enough to provide adequate machining area and the component can be moved smoothly over the rail because the coefficient of drag between rail and moving area is minimal. The angular connector 502 may rotate 360 degrees around the bumped out circular profile which is on the index plate 108. By rotating the angular connector 502 about its axis it allows the power tool 112 to work along different axes. Moreover, this allows for the tooling on the grinder to perform angular cuts and grinds by setting the desired angle, which is on the index plate 108 and also on the angular connector 502. The angle grinder attaches to the angular connector 502 by using countersunk bolts which may be in alignment with the whole pattern which holds the angle grinder reduction gear to its body.

The moving module 104 of the apparatus, named as the saddle is connected onto the rail 102. The saddle may have wheels made of metal, and the distance between the wheels on both sides may be equal to the width of the rail, which helps the saddle to stay on the top of the rail rigidly. The saddle may be inserted into the rail through one end of the rail and it may glided along the surface of the extended rail to perform machining operations. A metal plate 202 may be inserted into the rail to ensure smooth movement of the saddle along the rail. The plate may be locked into the two grooves on the top side of the extended rail 102.

In one example the side block 106 may be connected with the saddle 104 with the help of connecting rods 302. The side block 106 plays a major role in the operation of the apparatus as the power tool is connected to it. The connecting rods may move inside or outside of the saddle (part 104) with respect to the rotation of the long-threaded knob 114. The side block is locked into a fixed position by set screws 304. The screws 304 applies pressure to the threaded knob 114 which may rotate inside the saddle 104 and the side block 106. Further, the threaded knob 114 is fixed into the side block using the snap rings. All the connecting rods are well lubricated to ensure smooth movement as well as to prevent wear when the side block moves.

Furthermore, an index plate 108 connects to the side block 106 to move the power tool up and down for performing machining operations on the work piece. The index plate may be made of metal and may have grooves on both sides to move along the back side of side block. The movement of index plate may be locked into a fixed position by set screws 306 with a bolt that applies pressure to the index plate.

In addition to all the movements mentioned here till now, the power tool can be also adjusted angularly. The power tool used, for example, a hand grinding machine, is connected to 108 with an angular connector 502. It is an L-shaped metallic connector with the bottom side flattened and the top side rounded. It may be rotated to any required angle by loosening the countersunk bolt which connects 502 to 108. In this example, the angles are marked with an interval of 22.5°, which means the distance between two consecutive markings is 22.5°. The power tool can be connected to the flat bottom side of the angular connector by inserting the shaft of the power tool blade through the hole provided in 502.

The entire configuration is fixed on to the work piece with the clamps 110. In this example, a single clamp is represented, but more than one clamps may be used to ensure the safety of the arrangement. The clamp has mainly three parts: the handle, portion attaching to the rail, and a rotating part that fix the apparatus. The top portion of the clamp is inserted into the two grooves provided on the rail and is moved along the groove and fixed to the machining surface with the rotating part. The arrangements are very simple and easy to detach even without any other tools.

The apparatus acts like a sophisticated adapter for an angle grinder to be attached within the assembly. In addition to angle grinders, other suitable power tools used for similar use cases may also be attached to the assembly as understood by a person skilled in the art. The attachment may glide laterally on the extruded aluminum profile 102 that may be securely fastened with profile clamps 110 to a work piece of any length, provided that the rail is longer than the work piece. The rail may have stainless steel rods on either side that may allow the stainless-steel wheels of the side block 104 to couple around and sit firmly on a sliding track which provides lateral movement of the tool in the (X-axis) or for side-to-side movement.

It may be noted that the apparatus is portable, it does not affect the usability of the power tool, besides it stabilizes it and increases the accuracy of operation. Since the power tool can be mounted on the apparatus, it is very convenient for the operator. Moreover, the apparatus can be carried to heavy and large materials, which are to be machined, which is a great advantage compared to existing technologies. The prior arts are either in one way are not portable or the work piece should be brought to the apparatus for machining. This may not be practically possible in case of materials having large surface area or for work pieces that are heavy. Even with a highly skilled operator, it is not easy to perform machining operations at a particular angle or in large, contoured surfaces for long time, since he may become tired. But with this present disclosure, operator may be able to perform machining operations for long time by mounting the power tool to the apparatus and by presetting the required angle with the angular connector.

The primary advantage of the apparatus may be convenience it provides to operators in several real-life situations. During machining process, operators may suffer the risk of injury, vibration of the machine and the fire and heat produced because of machining processes. Once the grinding machine is fixed on to the apparatus, it is free to move by sliding the saddle through the extended rail. In addition, any angle can be set on the apparatus for performing machining operations. The whole operation will be effortless, since the power tool is rigidly and safely mounted on the apparatus. Also, safety of operation will increase substantially. Even an operator without much experience can perform machining operations with this apparatus.

The advantage of the present disclosure over the prior arts includes an increased scope for human-machine interaction while performing complex cutting, polishing, grinding, and related processes on different types of work pieces. Specifically, while working on decorative sheet materials and countertops of different sizes and thickness, computer aided cutting may not be able to efficiently perform the said operating since processing may involve working across multiple axes. It becomes nearly impossible for currently available automated systems to perform such operations uniforms across different types of surfaces due to variation in sheet size, thickness, and density. It may require the system to be re-programmed per each work piece when it comes to automated processing of such wide variety of materials. Hence, an efficient apparatus such as the one described in the present disclosure, that allows humans to interact with the machine via simple means to perform the different dressing functions will be highly advantageous in practical scenarios. Herein, attachments such as angle grinder may be used precisely at any continuous length to process an edge of a sheet material efficiently.

The present disclosure provides added safety to workmen by providing them a secure apparatus that allows them to work with added confidence since they needn't worry much about maintaining precision (the apparatus takes care of the same ones the parameters are set). Since the angles and movements are fixed and the work piece is securely clamped in the assembly, workmen needn't worry about losing control over the process while performing necessary functions. In conventional apparatuses, workmen are prone to injuries caused by flying debris since they try to keep their eyes open or remove their safety glasses for better visibility to avoid mistakes. The apparatus proposed by the present disclosure completely avoids such scenarios and provides added safety and confidence to the workmen and provides efficient results in terms of precision as well. Furthermore, the instant invention has incorporated the protective shroud in such a way that it will not crash into the sheet that is being processed under any circumstance created by an attachment on the angle grinder. The instant solution is versatile, light weight, safe. It provides an easy and efficient solution for processing of large sheet material and other hard surfaces.

The apparatus allows performing the following functions with high precision and safety: continuous linear cutting of sheet material of a plurality of thickness, continuous angled (any angle) linear cutting of any sheet materials of a plurality of thickness, boring holes vertically through the surface of sheet materials of a plurality of thickness, grinding and/or dressing a continuous edge of sheet material of a plurality of thickness at any angle desired by the operator, and routing a continuous edge of a sheet material with any profile available for attachment onto an angle grinder.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All the features disclosed in this specification (including any accompanying claims, abstract and drawings), and/or all of the steps of any method or process so disclosed, may be combined in any combination, except combinations where at least some of such features and/or steps are mutually exclusive.

The apparatus described herein may be manufactured in different dimensions so as to cover wide range of materials to be machined. It may also use to attach different kind of power tools other than grinding machine. The dimensions may be varied to accommodate different types of materials needed to be machined such as granite, marble, metals, and so on.

It may be stated that the apparatus allows power tools to operation in multiple axes. While the movement of the saddle along the extended rail comprises the first axis, the movement of the index plate in vertical direction provides the second axis of operation. The third axis includes the movement of the power tool as allows by the angled connector. The final axis includes the movement of the side block with respect to the saddle as allows by the connecting rods. The distance between the saddle and the side block may be adjusted herein. Hence, it may be stated that the apparatus enables movements in 4 axes (X, Y, Z, AB) thereby allowing precise, continuous linear processing of different types of work pieces. In one example, work pieces with surfaces that are suitable for countertops and other surface coverings may be processed using the instant apparatus. It is also suitable for processing any other sheet/panel material with the attachment of corresponding bits onto the angle grinder's arbor in accordance with the type of sheet material being processed.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The present description has been shown and described with reference to the foregoing examples. It is understood, however, that other forms, details, and examples can be made without departing from the spirit and scope of the present subject matter that is defined in the following claims.

What is claimed is:

1. An apparatus comprising:
an extended rail;
a saddle, movably mounted on top of the extended rail such that the sides of the saddle locks onto either side of the extended rail;
a side block connected to the lateral side of the saddle using length adjustable connecting rods, wherein the distance between the side block and the saddle can be altered using the length adjustable connecting rods;
one or more clamps that securely fastens a machining surface to the apparatus by clamping the machining surface to the bottom portion of the extended rail;
a coolant pipe removably attached to the side block for ejecting coolant onto the machining surface;
an index plate removably attached to the side block onto which a power tool can be mounted using an angled connector that allows the power tool to be fixed onto the index plate at a plurality of angles, wherein the power tool comprises of a motor and a set of replaceable blades rotatably connected to the motor for performing operations including cutting, grinding, or polishing of the machining surface.

2. The apparatus of claim 1, wherein a bolt fastens the length adjustable connecting rods to the side block.

3. The apparatus of claim 1, wherein a first end of the clamp is movable connected into a groove that extends throughout the bottom portion of the extended rail.

4. The apparatus of claim 3, wherein a second end of the claim is fastened onto the machining surface.

5. The apparatus of claim 1, wherein the first end of the coolant pipe is connected to a coolant source.

6. The apparatus of claim 5, wherein the second end of the coolant pipe is connected to a coolant inlet provided on the side block.

7. The apparatus of claim 6, wherein a flexible nozzle is connected to a coolant outlet provided on the side block.

8. The apparatus of claim 7, wherein the flexible nozzle can be adjusted to point towards a plurality of contact points where the set of replaceable blades operates on the machining surface.

9. The apparatus of claim 1, wherein the angled connector allows the power tool to be adjusted and fixed in a plurality of angles to provide a plurality of operational angles to the power tool.
